(19) United States
(12) Patent Application Publication
(10) Pub. No.: US 2010/0107293 A1
(43) Pub. Date: May 6, 2010

(54) DEVICES AND METHODS OF PROTECTING AND REINFORCING GARMENTS

(75) Inventors: Timothy Kowal, Windsor, CT (US); Rengan Kannabiran, Wayland, MA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: SCAPA NORTH AMERICA, Windsor, CT (US)

(21) Appl. No.: 12/263,402

(22) Filed: Oct. 31, 2008

(51) Int. Cl. A41D 27/12; B32B 38/04

(52) U.S. Cl. 2/46; 156/510

(57) ABSTRACT

A patch for reinforcing a desired area of a garment. The patch comprises a backing substrate and an adhesive layer attached to a side of the backing substrate. At least one edge of the patch is cut in a notched pattern such that the patch has a defined area less than the desired area of the garment. A method for reinforcing a desired area of a garment. A patch is provided comprising a backing substrate and an adhesive layer attached to a side of the backing substrate. The patch is cut such that the patch has a defined area less than the desired area of the garment, and is then applied to the desired area of the garment. A method for reinforcing a desired area of a garment. A patch is provided comprising a backing substrate and an adhesive layer attached to a side of the backing substrate. At least one edge of the patch is cut in a notched pattern such that the patch has a defined area less than the desired area of the garment. The cut patch is then applied to the desired area of the garment.

### BACKGROUND

1. Field

This disclosure relates to adhesive patches for protecting and reinforcing a desired area of a garment and methods of protecting and reinforcing a desired area of a garment with an adhesive patch shaped to facilitate conformability to the garment.

2. General Background

Garments, such as overalls and uniforms, often have pouches or pockets that experience various levels of load, stress, and abrasion from objects carried within them. Therefore, there is a need for an adhesive patch that can be easily applied to a curved area, such as the inside or outside of a pouch or pocket, to provide additional reinforcement and protection against wear and tear.

Cloth-backed adhesives, tapes, and bandages have been used for multiple purposes. Bandages and wound dressings are applied on human skin and focus on flexibility and thinness, therefore rendering them unsuitable for garment reinforcement and abrasion protection. Other common cloth-backed adhesives and tapes are also too flexible and thin for the purposes stated and are often shaped to match or cover a planar area that does not experience the tensile or compressive stresses associated with pockets, pouches, and other curved areas. Increasing the stiffness and thickness of common cloth-backed adhesives and tapes result in the tendency for the edges of the cloth-backed adhesives and tapes to lift or separate from the garment over time and when stresses are applied.

### SUMMARY

In accordance with one aspect of the present disclosure, a method is disclosed for reinforcing a desired area of a garment. The method comprises providing a patch comprising a backing substrate and an adhesive layer attached to a side of the backing substrate, cutting the patch such that the patch has a defined area less than the desired area of the garment, and applying the patch to the desired area of the garment.

A method is also disclosed for reinforcing a desired area of a pouch or pocket of a garment. The method comprises providing a patch comprising a backing substrate and an adhesive layer attached to a side of the backing substrate, cutting at least one edge of the patch in a notched pattern such that the patch has a defined area less than the desired area of the garment, and applying the patch to the desired area of the garment. In exemplary implementations, the adhesive layer is a pressure sensitive adhesive layer.

In accordance with another aspect of the present disclosure, a patch is disclosed for reinforcing a desired area of a garment. The patch comprises a backing substrate and an adhesive layer attached to a side of the backing substrate, wherein at least one edge of the patch is cut in a notched pattern such that the patch has a defined area less than the desired area of the garment.

### DRAWINGS

The above-mentioned features and objects of the present disclosure will become more apparent with reference to the following description taken in conjunction with the accompanying drawings wherein like reference numerals denote like elements and in which:

FIG. 1 is a plan view of one exemplary embodiment of an adhesive patch applied to a garment area.

FIG. 2 is a plan view of another exemplary embodiment of an adhesive patch applied to a garment area.

FIG. 3 is a plan view of one exemplary shape of an adhesive patch.

FIG. 4 is a plan view of another exemplary shape of an adhesive patch.

FIG. 5 is a plan view of an adhesive patch applied to an interior curved surface of a pocket.

FIG. 6 is a cross-sectional view of the adhesive patch applied to the interior curved surface of the pocket.

### DETAILED DESCRIPTION

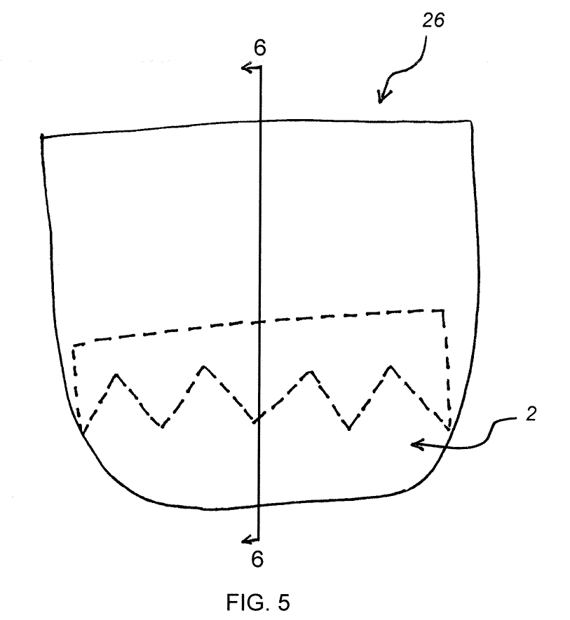

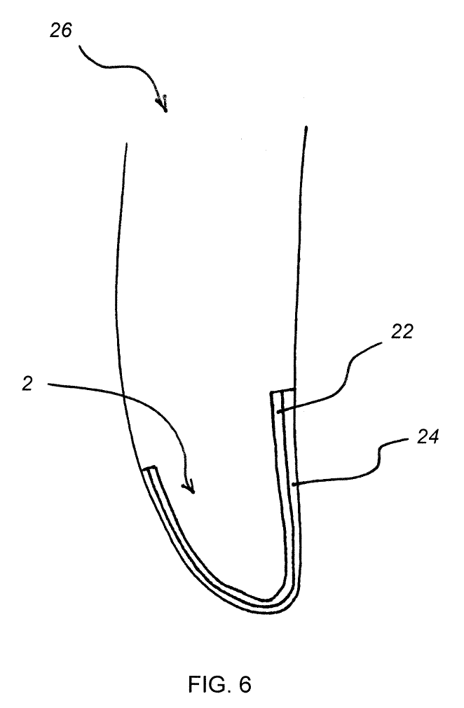

In accordance with one aspect of the present disclosure, a method is disclosed for reinforcing a desired area of a garment. The method comprises providing a patch comprising a backing substrate and an adhesive layer attached to a side of the backing substrate, cutting the patch such that the patch has a defined area less than the desired area of the garment, and applying the patch to the desired area of the garment. FIG. 6 is a cross-sectional view of FIG. 5 illustrating an adhesive patch 2 comprising a backing substrate 22 and an adhesive layer 24 attached to the interior curved surface of a pocket 26.

Depending on factors such as the desire to match the material of the garment or a desired stiffness, strength, texture, or feel of the patch, the backing substrate of the patch may be made of materials including, but not limited to, nylon, wool, nylon/cotton blends, aramid fiber, polyester/nylon blends, polyester/cotton blends, cotton/spandex blends, vinyl, urethane, rubber, plastic, and other natural and synthetic materials commonly used in the textile industry. The backing substrate may be a cloth, film, or composite layer of woven or non-woven sheets. The number, orientation, and order of layers may be varied depending on desired reinforcement and protection qualities. The backing substrate may also have additional coatings, such as a water-proof coating and urethane coating.

Attached on one side of the backing substrate is an adhesive. Multiple layers or pattern coatings of adhesive may also be used. Suitable adhesives include, but are not limited to, polyurethane, silicone type, acrylic type, rubber type (including styrenic block copolymer, synthetic/natural polyisoprene), epoxy type, phenolic type, polyimide type. The adhesives may be solvent-borne, water-borne, or 100% solids, and may be pressure sensitive, solvent activated, heat activated thermosetting or thermoplastic, or water activated. The adhesive used may be decided by various factors, including the desired adhesiveness, ease of removal, target adhesion surface, and conditions of extended use. Preferably, the adhesive is formulated to withstand several wash cycles or other conditions encountered during the use of the garment. The adhesive may also include additives such a fillers, preserving agents, pigments, resins, tackifiers, plasticizers, fire retardant additives or mixtures thereof depending on the desired characteristics. A release liner may also be included to cover the adhesive before use of the patch.

In exemplary implementations, the adhesive is a pressure sensitive adhesive (PSA) from a family of materials including acrylate or blends of acrylate and other elastomeric compositions. The PSA may be hot melt, solvent cast, or solution cast. A PSA layer provides the convenience of applying the adhesive patch to a garment by normal hand pressure or by using commonly available items like a spoon or hard squeegee etc. In other exemplary implementations, the adhesive is a heat seal adhesive, such as EVA, polyester, polyurethane, nitrile phenolic, or other adhesives used in heat lamination processes. An iron or other heat source may be used to activate the heat seal adhesive, resulting in a tight adhesion between the adhesive patch and garment.

To provide reinforcement and protection against wear, the patch is usually thicker and stiffer than common adhesive tapes and medical bandages. The thickness and stiffness may be separately adjusted for specific desired characteristics. For example, round urethane dots may be dispersed on a polyester nylon blend fabric to make it stiffer and the thickness may change depending on the location of the dots. However, simply increasing the thickness and stiffness of a patch results in an increased tendency for the edges to lift when the patch is attached to a curved surface, such as the inside of a pouch or pocket 26, as shown in FIG. 5. Therefore, the disclosed adhesive patch is designed and cut in a shape which allows stress relief on specific areas of the patch that are adhered to the garment, while maintaining a reinforcing stiffness to a desired area of the garment. Factors such as the adhesive strength of the patch, the curvature of the desired area of the garment, the amount of movement at the desired area, the amount of friction associated with objects in contact with the desired area, and the material of the desired area may contribute to the determination of a most suitable shape for the patch.

The shape of the adhesive patch may include extensions or elongated areas, in various lengths, numbers, and shapes. The extensions or elongated areas could also be used as a reinforcement design for purposes such as supporting pouches in holding articles without the need for additional reinforcement. In one exemplary implementation, the edges of a patch are notched in a triangular pattern to prevent undesired lifting of the edges due to bending or compression of flaps in a uniform. The shape of the adhesive patch may also include cutouts within the patch. In one exemplary implementation, a patch includes rows of diamond shaped cutouts that match the bends on the inside of a pocket.

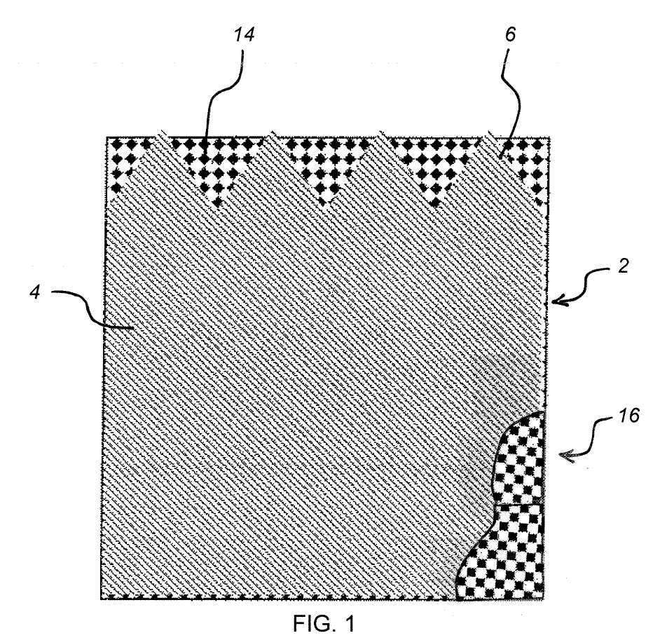

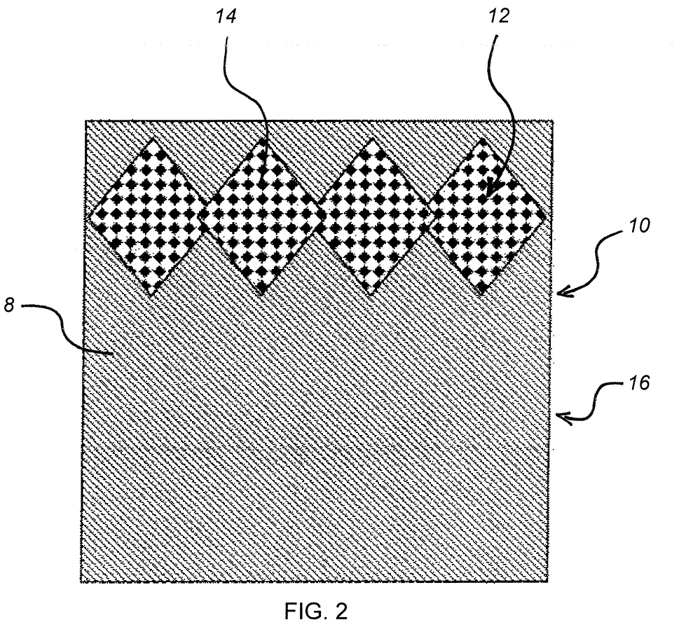

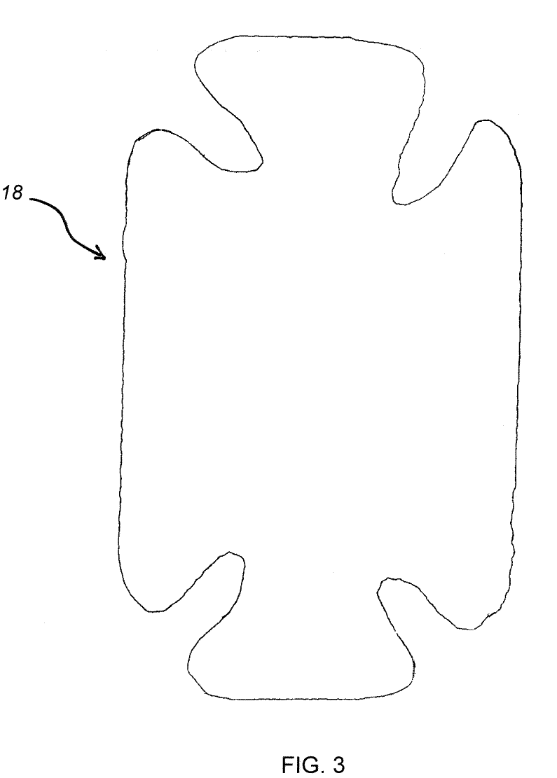

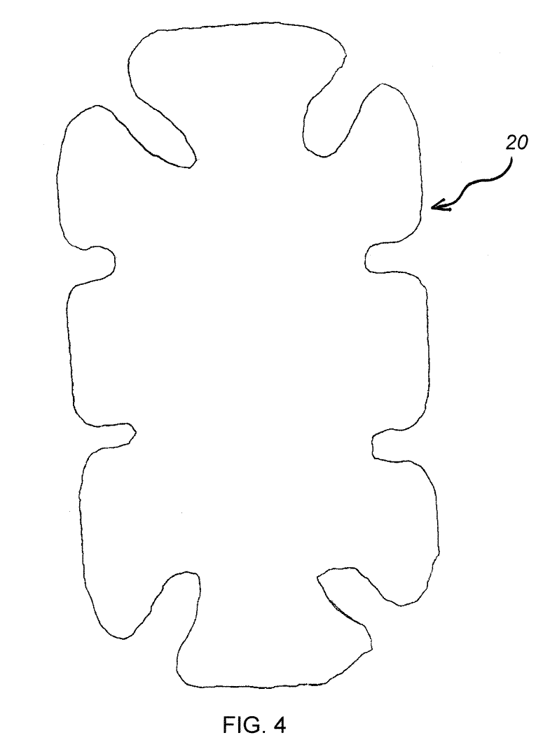

The patch is shaped or cut in a way such that the ratio of the defined area of the patch to the desired area of the garment is less than 1. The defined area of the patch is the surface area of the patch after it has been designed or cut to the desired shape. The desired area of the garment is the surface area of the garment that would be protected and/or reinforced by the patch prior to its shaping and cutting for improvement in conformability and adhesion. In exemplary implementations, the defined area of the patch to the desired area of the garment is a ratio between 0.25 and 0.9. Several shape designs may be used to meet the area ratio requirements. FIGS. 1 and 2 show two possible patch shapes. In FIG. 1, the defined area 4 of the patch is represented with a diagonal shading with a cut away on the bottom right hand corner to show the garment 16 underneath. FIG. 1 shows a patch 2 with a notched V-shaped edge 6. Similarly, in FIG. 2, the defined area 8 of the patch is represented with a diagonal shading. FIG. 2 shows a patch 10 with diamond cutouts 12. The desired area 14 of the garment 16 is the rectangle underneath patches 2, 12 having a checkered pattern. The desired area of the garment is visible only in areas where the patch is cutout. Other shapes and cutouts that may be used for the patch include but are not limited to star shapes, circular cutouts, star shaped cutouts, semi-circle edges, curved edges, and other geometric shapes and combinations thereof. FIGS. 3 and 4 show two other possible shapes as patches 18, 20.

A method is disclosed for reinforcing a desired area of a pouch or pocket of a garment. The method comprises providing a patch comprising a backing substrate and an adhesive layer attached to a side of the backing substrate, cutting at least one edge of the patch in a notched pattern such that the patch has a defined area less than the desired area of the garment, and applying the patch to the desired area of the garment. In exemplary implementations, the adhesive layer is a pressure sensitive adhesive layer.

In accordance with another aspect of the present disclosure, a patch is disclosed for reinforcing a desired area of a garment. The patch comprises a backing substrate and an adhesive layer attached to a side of the backing substrate, wherein at least one edge of the patch is cut in a notched pattern such that the patch has a defined area less than the desired area of the garment.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method for reinforcing a desired area of a garment, the method comprising:
providing a patch comprising a backing substrate and an adhesive layer attached to a side of the backing substrate;
cutting the patch such that the patch has a defined area less than the desired area of the garment; and
applying the patch to the desired area of the garment.

2. The method of claim 1 wherein the adhesive layer is a pressure sensitive adhesive layer.

3. The method of claim 1 wherein the desired area of the garment is a curved area of one of a pouch and pocket.

4. The method of claim 1 wherein the defined area of the patch to the desired area of the garment is a ratio between 0.25 and 0.9

5. A method for reinforcing a desired area of a pouch or pocket of a garment, the method comprising:
providing a patch comprising a backing substrate and an adhesive layer attached to a side of the backing substrate;
cutting at least one edge of the patch in a notched pattern such that the patch has a defined area less than the desired area of the garment; and
applying the patch to the desired area of the garment.

6. The method of claim 5 wherein the adhesive layer is a pressure sensitive adhesive layer.

7. The method of claim 5 wherein the notched pattern is one of a V-shaped and semi-circle pattern.

8. The method of claim 5 wherein the defined area of the patch to the desired area of the garment is a ratio between 0.25 and 0.9.

9. A patch for reinforcing a desired area of a garment, the patch comprising:
a backing substrate; and
an adhesive layer attached to a side of the backing substrate;
wherein at least one edge of the patch is cut in a notched pattern such that the patch has a defined area less than the desired area of the garment.

10. The patch of claim 9 wherein the adhesive layer is a pressure sensitive adhesive layer.

11. The patch of claim 9 wherein the notched pattern is one of a V-shaped and semi-circle pattern.

12. The patch of claim 9 wherein the defined area of the patch to the desired area of the garment is a ratio between 0.25 and 0.9.
